(19) United States
(12) Patent Application Publication
(10) Pub. No.: US 2020/0029600 A1
(43) Pub. Date: Jan. 30, 2020

(54) METHOD OF MANUFACTURING BEVERAGE WITHIN CONTAINER

(71) Applicant: Livewell Collective, LLC, Columbus, OH (US)

(72) Inventor: Dave Colina, Cincinnati, OH (US)

(73) Assignee: Livewell Collective, LLC, Columbus, OH (US)

(21) Appl. No.: 16/523,401

(22) Filed: Jul. 26, 2019

Related U.S. Application Data
(60) Provisional application No. 62/703,851, filed on Jul. 26, 2018.

(51) Int. Cl. A23L 2/54; A23L 2/60; A23L 2/46; B01F 3/04; B01F 3/08; B67C 3/02; B67C 7/00

(52) U.S. Cl. CPC A23L 2/54; A23L 2/60; A23L 2/46; B01F 3/04794; B01F 3/0803; A23V 2002/00; B67C 7/00; B01F 2003/04879; B01F 2003/0888; B01F 2215/0022; B67C 3/023

(57) ABSTRACT

Oxygenated beverages are described herein and methods for production of same. In an embodiment, a beverage delivery system is described including a container and an oxygen-containing aqueous liquid wherein the dissolved oxygen content is from about 25 ppm to about 50 ppm, where the liquid and a gas comprising oxygen within the container provide a pressure force of about 20 PSI to about 35 PSI on the interior surfaces of the container, and wherein the nitrogen content is very low causing a force of less than 17 PSI on the interior surfaces of the container.

This application claims the benefit of U.S. Provisional Application No. 62/703,851, filed on Jul. 26, 2018, which is hereby incorporated by reference herein in its entirety.

### TECHNICAL FIELD

Oxygenated beverages are described herein and methods for production of same.

### BACKGROUND

Beverages are often manufactured at a processing center and then shipped to distributors located at geographically diverse locations. To ship beverages to the geographically diverse locations, the containers holding the beverages are formed to have a structural integrity that is configured to prevent damage to the container during a shipping process. For example, if the structural integrity of a container holding a beverage is insufficient the container may become damaged during shipping, resulting in loss of the beverage or a product that cannot be sold.

One type of container that is often used to hold a beverage is aluminum cans. It has been appreciated that often the physical characteristics of an aluminum can do not provide for a sufficient amount of structural rigidity to prevent damage (e.g., dents) to the can during shipping. However, by pressuring an interior of the aluminum can the structural rigidity of a can may be increased so as to reduce damage to the can. For example, in carbonated beverages dissolved carbon dioxide in a liquid within a can will exit the liquid after closing the can. The carbon dioxide exiting the liquid will cause a pressure within the can to increase. The increased pressure within the can causes a force to push on interior surfaces of the can, thereby providing the can with an increased structural rigidity. Alternatively, in non-carbonated beverages a liquid can be dosed with nitrogen prior to closure of the can. The nitrogen subsequently leaves the liquid and increases a pressure within the can, thereby giving the can with an increased structural rigidity. However, the inclusion of nitrogen to increase a rigidity of the can may increase a cost of manufacturing by adding an additional step in the manufacturing process.

### SUMMARY

A beverage delivery system is provided and methods of producing same. The beverage delivery system includes: a container comprising a sidewall coupled between an upper surface and a lower surface; an aqueous liquid disposed within the container, the aqueous liquid comprising an oxygen content of greater than about 25 ppm (parts per million); wherein the aqueous liquid and a gas comprising oxygen within the container are configured to provide for a pressure in a range of between approximately 20 PSI and approximately 35 PSI on interior surfaces of the container; and wherein oxygen within the container causes a force to push on the interior surfaces of the container. The dissolved oxygen content in the finished oxygenated aqueous beverage can be greater than 35 ppm, or greater than 45 ppm, up to about 50 ppm.

In an embodiment, a method of forming a beverage is provided, including the steps of: providing an aqueous liquid within a container, the aqueous liquid substantially devoid of oxygen; dosing the aqueous liquid with liquid oxygen, wherein dosing the aqueous liquid with oxygen causes the aqueous liquid to have an oxygen concentration within the aqueous liquid that is greater than 25 ppm; and closing the container to seal the aqueous liquid within the container, wherein the contents of the container push on interior surfaces of the container with a pressure in a range of between approximately 20 PSI and approximately 35 PSI after closing the container.

### BRIEF DESCRIPTION OF THE DRAWINGS

FIG. 1 depicts a block diagram of a manufacturing apparatus in accordance with one embodiment of the present invention.

FIG. 2 depicts in an alternative embodiment a manufacturing apparatus configured to produce a can containing an oxygenated liquid.

FIG. 3 depicts embodiments of a container containing an oxygenated liquid in accordance with the present invention.

FIG. 4 depicts a flow diagram showing a method of manufacturing a container containing an oxygenated liquid in accordance with the present invention.

### DETAILED DESCRIPTION OF THE INVENTION

The present disclosure relates to a method of manufacturing an oxygenated beverage within a container (e.g., can) and an associated product. The method is able to manufacture a non-carbonated oxygenated beverage in a container having a sufficient structural rigidity to prevent damage (e.g., during shipping and/or pasteurization) without dosing the liquid with nitrogen. For example, the can may have an interior pressure in a range of between approximately 20 PSI (pounds per square inch) and approximately 35 PSI.

The resulting product comprises a container (e.g., an aluminum can) surrounding an oxygenated beverage that is substantially devoid of nitrogen (e.g., a nitrogen content that causes a pressure of less than approximately 17 PSI on interior surfaces of the container). The oxygenated beverage has more than 25 PPM (parts per million) of dissolved oxygen achieved through a dose of liquid oxygen. The oxygen content of the beverage is configured to accelerate muscle recovery and accelerate the rate at which the liver processes post-workout and ingested toxins.

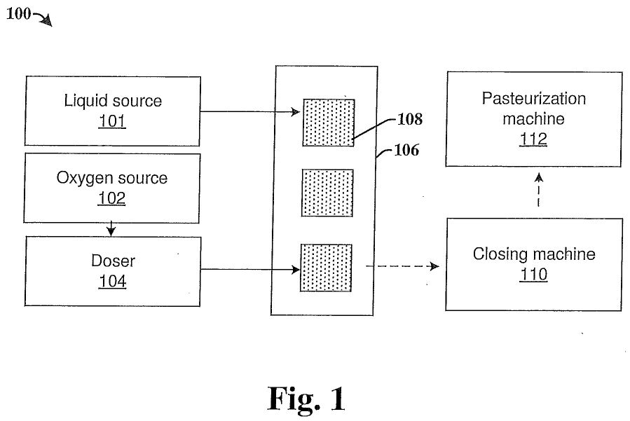

FIG. 1 illustrates a block diagram of a manufacturing apparatus 100 configured to generate a can comprising an oxygenated liquid.

The manufacturing apparatus 100 comprises a liquid source 101. The liquid source 101 is configured in such a manner that a liquid is provided into containers 108 (e.g., aluminum cans). In some embodiments, the liquid may comprise water. In some embodiments, the liquid may be substantially devoid of oxygen (e.g., does not contain a substantial amount of oxygen). In some embodiments, the liquid may be completely devoid of oxygen.

The manufacturing apparatus 100 also comprises an oxygen source 102 coupled to an injection element comprising a doser 104 by a conduit configured to transfer oxygen. The oxygen source 102 is configured to store oxygen. In some embodiments, the oxygen source 102 may be configured to store liquid oxygen. The injection element 104 is in communication with a plurality of containers 108 that are on a manufacturing line 106 configured to transport the containers 108.

The injection element 104 is configured to dose a liquid within the containers 108 with liquid oxygen (e.g., to provide liquid oxygen into a liquid within the containers 108). In some embodiments, a liquid within the containers 108 is dosed with liquid oxygen at a flow rate of greater than approximately 1.2 mm³ per millisecond (mm³/ms). In some additional embodiments, a liquid within the containers 108 is dosed with liquid oxygen at a flow rate of greater than approximately 1.5 mm³ per millisecond (mm³/ms). In some additional embodiments, a liquid within the containers 108 may be dosed with liquid oxygen at a flow rate that is in a range of between approximately 1.2 mm³/ms and 2 mm³/ms. Dosing a container 108 with liquid oxygen will allow for the oxygen to both achieve a desired concentration of oxygen within the liquid (e.g., that is greater than 25 ppm) and also to achieve a pressure within a container 108 that increases a structural rigidity of the container 108 (e.g., that is greater than approximately 15-20 PSI) In contrast, adding oxygen gas to a liquid prior to adding the liquid to the container is unable to both achieve a desired concentration of oxygen within the liquid and also to also achieve a pressure within a container 108 to greater than approximately 15-20 PSI.

It has been appreciated that dosing a liquid within the containers 108 at a flow rate of greater than approximately 1.2 mm³/ms allows for the liquid to contain a both a sufficient level of oxygen to subsequently pressurize the container 108 after closing the container (e.g., at a pressure of above 25 PSI). At a flow rate of less than approximately 1.2 mm³/ms the amount of liquid oxygen added to the liquid will be insufficient to pressurize the container 108 to a pressure that prevents damage (e.g., dents) to the container 108. It has further been appreciated that dosing a liquid within the containers 108 at a flow rate of greater than approximately 2 mm³/ms, will cause the pressure within the liquid to be high enough to cause the container 308 to burst during pasteurization. For example, during pasteurization the content of the container 308 is heated to an elevated temperature (e.g., above 150° F.). The elevated temperature increases a pressure of the gas within the container 308. If too much oxygen is added to the liquid, the oxygen within the container 308 may cause a pressure within the container 308 to be high enough to cause the container 308 to burst (e.g., to form one or more holes extending through the container).

A closure machine 110 is arranged downstream of the injection element 104. The closure machine 110 is configured to close the container 108 after a liquid within the container 108 is dosed with oxygen. Closing the container 108 causes the container to be sealed (e.g., hermetically sealed) so as to prevent liquid and/or gas from immediately leaving the container 108. In some embodiments, the closure element 110 may comprise a can seamer.

A pasteurization machine 112 is arranged downstream of the closure element 110. The pasteurization machine 112 is configured to perform a pasteurization process on the container 108 and the liquid within the container 108. In some embodiments, the pasteurization machine 112 may comprise a tunnel pasteurization machine configured to perform tunnel pasteurization. In other embodiments, the pasteurization element may comprise a flash pasteurization machine, or the like.

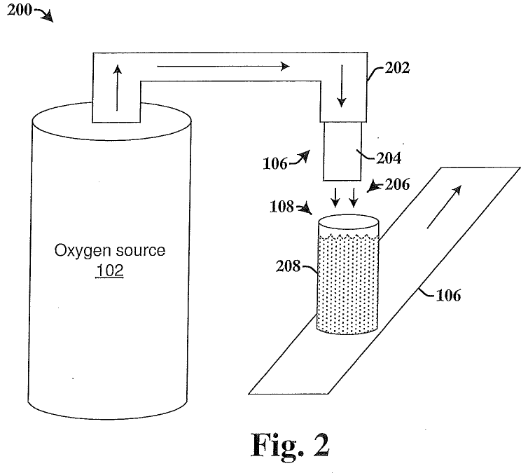

FIG. 2 illustrates some additional embodiments of a manufacturing apparatus 200 configured to generate a can 108 comprising an oxygenated liquid composition or fluid 208.

The manufacturing apparatus 200 comprises an oxygen source 102 comprising an oxygen tank configured to store liquid oxygen. In some embodiments, the oxygen source 102 comprises a medical grade or food grade liquid oxygen (e.g., a liquid oxygen that is in a tank that is subject to the chain of custody of medical or food grade oxygen). The oxygen source 102 is coupled to an injection element 106 comprising a doser 204 by way of a conduit 202. In some embodiments, the conduit may comprise a tube.

A useful doser includes UltraDoser (also used for liquid nitrogen in other applications) dosing system available from Vacuum Barrier Corp. (Woburn, Mass.).

In some embodiments, the doser 204 may have a cylindrically shaped outer surface that surrounds an opening extending through an axis of the cylinder shaped doser. The opening is configured to selectively transfer liquid oxygen from the conduit 202, through an opening extending through a center of the cylindrical shape of doser 204, and to a liquid 208 within a container 108. The opening is coupled to a valve that controls the flow of liquid oxygen. In some embodiments, the valve is configured to be controlled by a control unit to open for a time that provides for a dose of approximately 25-50 ppm (e.g., 0202 ml liquid oxygen for a 16 fluid ounce container). In some embodiments, the control unit is configured to open the valve for a time in a range of between approximately 10 ms and approximately 15 ms to dose a single container 108. In some embodiments, the container 108 is arranged on a manufacturing line 106 comprising a conveyer that moves in a path past the injection element 106.

For example, in a preferred embodiment, a bulk tank of liquid oxygen 102 is substituted for a standard tank of liquid nitrogen in a system. The liquid oxygen tank 102 is fitted with a vacuum insulated withdrawal system and connected to a conduit 202 comprising a vacuum insulated pipe. The conduit 202 is fitted inline with a phase separator further connected to the doser 204 further having a PLC controller. The doser 204 with controller is suitable for use with liquid oxygen and is used to deliver liquid oxygen into the system.

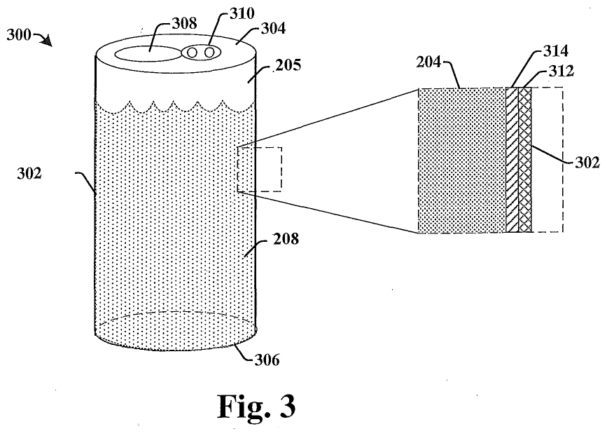

FIG. 3 illustrates some embodiments of a container 300 comprising an oxygenated aqueous liquid 208.

The container 300 comprises a casing having an outer sidewall 302 extending between an upper surface 304 and a lower surface 306. In some embodiments, the outer sidewall 302 may comprise a smooth surface having a cylindrical shape. The upper surface 304 comprises an access region 308 and an opening element 310. The opening element 310 is configured to open the access region 308 to enable a liquid 208 to be removed from the container 300 and consumed. In some embodiments, the access region 308 may be defined by an indentation in the upper surface 304. Along the indentation, the upper surface 304 may have a smaller thickness than outside of the indentation. In such embodiments, the opening element 310 may push on the access region with a force that is sufficient to sever the access region from the upper surface along a boundary of the access region 308. In an embodiment, the opening element 310 and the access region 308 may comprise a standard soda pop can tab assembly.

The container 300 is filled with contents that comprise an oxygenated aqueous liquid 208 and one or more gasses 205. The oxygenated liquid 208 has an oxygen content that is greater than approximately 25 ppm. The oxygen content of the oxygenated liquid 208 is configured to improve functionality of a drinker's liver, by allowing the liver to accelerate the processing of toxins within the drinker's blood. In some additional embodiments, the oxygenated liquid 208 may have an oxygen content that is greater than approximately 30 ppm. In yet other additional embodiments, the oxygenated liquid 208 may have an oxygen content that is greater than approximately 35 ppm. In yet other additional embodiments, the oxygenated liquid 208 may have an oxygen content that is greater than approximately 40 ppm. In yet other additional embodiments, the oxygenated liquid 208 may have an oxygen content that is greater than approximately 45 ppm. In yet other additional embodiments, the oxygenated liquid 208 may have an oxygen content that is about 50 ppm.

The oxygen content of the oxygenated liquid 208 within the container 300 provides for a pressure in a range of between approximately 20 PSI and approximately 35 PSI on interior surfaces of the container 300. It has been appreciated that if the pressure is less than 15-20 PSI, the container 300 may be subject to damage (e.g., dents), while if the pressure is greater than 35 PSI the oxygen content within the liquid will be high enough to cause the container 300 to burst during pasteurization. For example, during pasteurization the content of the container 300 is heated to an elevated temperature (e.g., above 150° F.). The elevated temperature increases a pressure within the container 300. If the container 300 has a contents with a pressure of greater than 35 PSI, the pressure within the container 300 may be high enough to cause the container 300 to burst during pasteurization of the oxygenated liquid 208.

In various embodiments, the content of the container 300 may comprise various amounts of nitrogen. In some embodiments, the content of the container 300 may have a nitrogen content that provides for less than 17 PSI of force pushing on interior surfaces of the container 300. In other embodiments, the content of the container 300 may have a nitrogen content that provides for less than 15 PSI of force pushing on interior surfaces of the container 300. In yet other embodiments, the content of the container 300 may have a nitrogen content that provides for less than 10 PSI of force pushing on interior surfaces of the container 300. In yet other embodiments, the content of the container 300 may have a nitrogen content that provides for less substantially no force pushing on interior surfaces of the container 300. In such embodiments, the content of the container 300 has substantially no nitrogen.

In some embodiments, the container comprises a metallic material 312 and a liner 314. The liner separates the metallic material 312 from an oxygenated liquid 208 within the container 300. The liner 314 is configured to prevent oxidation of the metallic material 312 by oxygen within the oxygenated liquid 208. In some embodiments, the metallic material 312 may comprise aluminum, steel, or the like. In some embodiments, the liner 314 may comprise bisphenol (BPA).

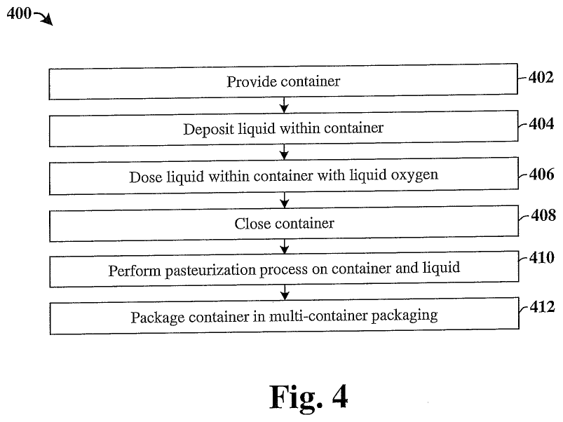

FIG. 4 illustrates a flow diagram 400 showing a method of manufacturing a container comprising an oxygenated liquid.

At 402, a container is provided. In some embodiments, the container may comprise an aluminum can with a liner that is configured to prevent oxidization of the aluminum. In some embodiments, the liner may comprise bisphenol (PBA).

At 404, a liquid is provided into a container. In some embodiments, the liquid may comprise water. The liquid is substantially devoid of oxygen (e.g., does not contain a substantial amount of oxygen).

At 406, the liquid within the container is dosed with liquid oxygen. In some embodiments, the liquid within the container is dosed with liquid oxygen at a flow rate of greater than approximately 1.2 mm³/ms. In some additional embodiments, the liquid within the container may be dosed with liquid oxygen at a flow rate of greater than approximately 1.5 mm³/ms. In some additional embodiments, the liquid within the container may be dosed with liquid oxygen at a flow rate in a range of between approximately 1.2 mm³/ms and approximately 2.0 mm3/ms. Using a flow rate of greater than 1.2 mm³/ms allows for the liquid to contain a sufficient level of oxygen to subsequently pressurize the container. Using a flow rate of less than 1.2 mm³/ms does not allow for the liquid to have an oxygen content will be sufficient to pressure a closed container. Dosing the liquid with liquid oxygen also gives the liquid a concentration of oxygen that is greater than 25 ppm.

At 408, the container is closed. Closing the container seals the liquid within the container. In some embodiments, the container may be capped by a can seamer (e.g., to form a pop tab).

At 410, a pasteurization process is performed on the container and the liquid within the container. In some embodiments, the pasteurization process may be performed by placing the container in an environment having a temperature of greater than 125° F. for greater than 15 minutes. In some additional embodiments, the pasteurization process may be performed on the container for 45 minutes at a temperature of up to 165° F. After closure of the container and/or pasteurization, the product can be chilled and/or stored at atmospheric pressure and room temperature.

At 412, the container is placed into a multi-container package. The container is packaged with an internal pressure in a range of between approximately 20 PSI and approximately 35 PSI and with a liquid having a 35 ppm dissolved oxygen content. In some embodiments, the container has a nitrogen content that is generates less than approximately 15 PSI on interior surfaces of the container (i.e., substantially free of nitrogen). In an embodiment, the dissolved oxygen content can be in a range of about 25 to about 50 ppm.

Therefore, in some embodiments, the method provided herein is a novel process to oxygenate water in a can that results in above 25 ppm dissolved oxygen, 20-35 pounds of pressure in the can or structural integrity and a product that can be tunnel pasteurized without compromising the finished goods packaging. A tank of food grade liquid oxygen is attached to a liquid nitrogen doser on an industrial manufacturing line. An aluminum can with a BPA liner that's filled with a water-based formulation and it is then dosed with liquid oxygen at a rate of 1.5 mm³/ms to 2 mm³/ms and then capped by industrial can seamer. The can itself containing the oxygenated fluid is then tunnel pasteurized for 45 minutes under temperatures up to 165° Fahrenheit and the resulting product is then delivered after tunnel pasteurization for case-pack packaging with a 20-35 PSI level and a 30+ppm dissolved oxygen content within the finished liquid and the finished goods products containing less than 17 PSI nitrogen.

In one embodiment, a use is an oxygenated water based product in an aluminum can with more than 35 PPM dissolved oxygen achieved through a dose of liquid oxygen, and no artificial ingredients (e.g., artificial flavors, sweeteners, or preservatives) to be ingested orally to accelerate muscle recovery and accelerate the rate at which the liver processes post-workout and ingested toxins.

### Formulation Example 1 (Citrus Mango—16 fl. Oz.)

| | Product Formula |
|---|---|
| Ingredient | weight (lbs) |
| Organic sugar (granular) | 27.54 |
| Erythritol (Zerose) | 250.33 |
| Truvia ® Stevia, 95% | 1.67 |
| Go-Luo ® Monk Fruit Extract #MOV04 | 0.83 |
| Malic acid | 25.03 |
| Citric acid | 12.52 |
| Sodium citrate dihydrate | 27.80 |
| Monopotassium phosphate* | 22.22 |
| Sweetness Enhancer #894807* | 2.50 |
| Caffeine, anhydrous* | 2.47 |
| Citrus Mango Flavor #890501* | 16.34^{a} |
| Oxygenated water | 8093.13^{b} |
| Finished Product Yield per Batch | 8482.38^{c} |
| Case Yield per Batch (12 × 16 fl. oz.) | 666 |

*Available from Flavorman (Louisville, Kentucky)
^{a}Volume is 2.00 gal.
^{b}Volume is 969.89 gal
^{c}1 + 4 syrup Yield per Batch is 1000.00 gal

In accordance with the table of Formulation Example 1 above, water was added to a mixing tank, withholding at least 3% of the water to adjust the final blend if necessary, and stirring was initiated. The aqueous mixture must be stirred at all times to insure that the ingredients go into solution easily. Organic sugar and erythritol were added and blended for 5 minutes. Next, Stevia, monk fruit extract, monopotassium phosphate, caffeine, and sodium citrate dihydrate were added and blended for 5 minutes. Next, Sweetness Enhancer #894807 and Citrus Mango Flavor #890501 were added and blended for 5 minutes. Finally, citric acid and malic acid were added and the mixture blended for 15 to 30 minutes. Product specifications were checked as shown in Table 1. Then, remaining water was added in an amount necessary to meet target specifications.

Blending times may be adjusted depending on batch size and blending equipment. The final product blend must be a well-blended batch without unnecessary blending.

The 1+4 syrup relates to the aqueous mixture of the base syrup of all the ingredients in 1 part, then combining with 4 parts water, before oxygen addition on the production line. Liquid oxygen is introduced to the product solution immediately before the cans are capped on the production line. In an example, water is combined with the syrup then put into a can, and then right before that can is capped a drop of liquid oxygen is dosed into the can to a) pressurize the can, and b) oxygenate the product.

TABLE 1

| Parameter | Tolerance | Method |
|---|---|---|
| Brix | 4.10-4.50 | Refractometer |
| Specific gravity | 1.0132-1.0149 | Densitometer |
| Total acidity (as citric) | 8.30-9.20 mL titrant | Titration |
| Nitrogen | Tunnel/Can spec | |
| Sensory | To match std. | |
| Color | To match std. | |
| pH | 3.50-3.90 | pH meter |
| Dissolved oxygen | 30-50 ppm | DO meter¹ |

¹Hanna Model HI 9143 portable DO Meter (Hanna Instruments, Smithfield, Rhode Island)

### Formulation Example 2 (Grapefruit Ginger—16 fl. oz.)

| Ingredient | Product Formula weight (lbs) |
|---|---|
| Organic sugar (granular) | 27.54 |
| Erythritol (Zerose) | 250.33 |
| Truvia ® Stevia, 95% | 1.67 |
| Go-Luo ® Monk Fruit Extract #MOV04 | 0.83 |
| Malic acid | 16.69 |
| Citric acid | 18.77 |
| Sodium citrate dihydrate | 27.80 |
| Monopotassium phosphate* | 22.22 |
| Caffeine, anhydrous* | 2.47 |
| Grapefruit Ginger Flavor #877204* | 16.59^{a} |
| Oxygenated water | 8096.01^{b} |
| Finished Product Yield per Batch | 8480.01^{c} |
| Case Yield per Batch (12 × 16 fl. oz.) | 666 |

*Available from Flavorman (Louisville, Kentucky)
^{a}Volume is 2.00 gal.
^{b}Volume is 970.24 gal
^{c}1 + 4 syrup Yield per Batch is 1000.00 gal

In accordance with the table of Formulation Example 2 above, water was added to a mixing tank, withholding at least 3% of the water to adjust the final blend if necessary, and stirring was initiated. The aqueous mixture must be stirred at all times to insure that the ingredients go into solution easily. Organic sugar and erythritol were added and blended for 5 minutes. Next, Stevia, monk fruit extract, monopotassium phosphate, caffeine, and sodium citrate dihydrate were added and blended for 5 minutes. Next, Grapefruit Ginger Flavor #877204 was added and blended for 5 minutes. Finally, citric acid and malic acid were added and the mixture blended for 15 to 30 minutes. Product specifications were checked as shown in Table 2. Then, remaining water was added in an amount necessary to meet target specifications.

Blending times may be adjusted depending on batch size and blending equipment. The final product blend must be a well-blended batch without unnecessary blending.

TABLE 2

| Parameter | Tolerance | Method |
|---|---|---|
| Brix | 4.10-4.50 | Refractometer |
| Specific gravity | 1.0132-1.0149 | Densitometer |
| Total acidity (as citric) | 8.60-9.55 mL titrant | Titration |
| Nitrogen | Tunnel/Can spec | |
| Sensory | To match std. | |
| Color | To match std. | |
| pH | 3.50-3.90 | pH meter |
| Dissolved oxygen | 30-50 ppm | DO meter¹ |

¹Hanna Model HI 9143 portable DO Meter (Hanna Instruments, Smithfield, Rhode Island)

### Formulation Example 3 (Lemon Lime—16 fl. oz.)

| Ingredient | Product Formula weight (lbs) |
|---|---|
| Organic sugar (granular) | 27.54 |
| Erythritol (Zerose) | 250.33 |
| Truvia ® Stevia, 95% | 1.67 |
| Go-Luo ® Monk Fruit Extract #MOV04 | 0.83 |
| Malic acid | 25.03 |
| Citric acid | 12.52 |
| Sodium citrate dihydrate | 27.82 |
| Monopotassium phosphate | 22.10 |
| Sweetness Enhancer #894807* | 2.50 |
| Natural Lemon Lime Flavor | 4.74^{a} |
| WONF# 153101* | |
| Oxygenated water | 8105.93^{b} |
| Finished Product Yield per Batch | 8481.02^{c} |
| Case Yield per Batch (12 × 16 fl. oz.) | 666 |

*Available from Flavorman (Louisville, Kentucky)
^{a}Volume is 0.66 gal.
^{b}Volume is 971.43 gal
^{c}1 + 4 syrup Yield per Batch is 1000.00 gal

In accordance with the table of Formulation Example 3 above, water was added to a mixing tank, withholding at least 3% of the water to adjust the final blend if necessary, and stirring was initiated. The aqueous mixture must be stirred at all times to insure that the ingredients go into solution easily. Organic sugar and erythritol were added and blended for 5 minutes. Next, Stevia, monk fruit extract, monopotassium phosphate, caffeine, and sodium citrate dihydrate were added and blended for 5 minutes. Next, Sweetness enhancer #894807 and Natural Lemon Lime Flavor WONF #153101 were added and blended for 5 minutes. Finally, citric acid and malic acid were added and the mixture blended for 15 to 30 minutes. Product specifications were checked as shown in Table 3. Then, remaining water was added in an amount necessary to meet target specifications.

Blending times may be adjusted depending on batch size and blending equipment. The final product blend must be a well-blended batch without unnecessary blending.

TABLE 3

| Parameter | Tolerance | Method |
|---|---|---|
| Brix | 3.90-4.30 | Refractometer |
| Specific gravity | 1.0125-1.0140 | Densitometer |
| Total acidity (as citric) | 7.95-8.90 mL titrant | Titration |
| Nitrogen | Tunnel/Can spec | |
| Sensory | To match std. | |
| Color | To match std. | |
| pH | 3.50-3.90 | pH meter |
| Dissolved oxygen | 30-50 ppm | DO meter¹ |

¹Hanna Model HI 9143 portable DO Meter (Hanna Instruments, Smithfield, Rhode Island)

### FORMULATION EXAMPLE 4 (Blackberry Currant-16 fl. oz)

| Ingredient | Product Formula weight (lbs) |
|---|---|
| Organic sugar (granular) | 27.54 |
| Erythritol (Zerose) | 250.33 |
| Truvia ® Stevia, 95% | 1.67 |
| Go-Luo ® Monk Fruit Extract #MOV04 | 0.83 |
| Malic acid | 25.03 |
| Citric acid | 12.52 |
| Sodium citrate dihydrate | 27.82 |
| Monopotassium phosphate | 22.10 |
| Sweetness Enhancer #894807* | 2.50 |
| Natural Blackberry Currant Type Flavor | 13.27^{a} |
| WONF# 153102* | |
| Oxygenated water | 8093.86^{b} |
| Finished Product Yield per Batch | 8477.47^{c} |
| Case Yield per Batch (12 × 16 fl. oz.) | 666 |

*Available from Flavorman (Louisville, Kentucky)
^{a}Volume is 1.60 gal.
^{b}Volume is 970.49 gal
^{c}1 + 4 syrup Yield per Batch is 1000.00 gal

In accordance with the table of Formulation Example 4 above, water was added to a mixing tank, withholding at least 3% of the water to adjust the final blend if necessary, and stirring was initiated. The aqueous mixture must be stirred at all times to insure that the ingredients go into solution easily. Organic sugar and erythritol were added and blended for 5 minutes. Next, Stevia, monk fruit extract, monopotassium phosphate, caffeine, and sodium citrate dihydrate were added and blended for 5 minutes. Next, Sweetness enhancer #894807 and Natural Blackberry Currant Type Flavor WONF #153102 were added and blended for 5 minutes. Finally, citric acid and malic acid were added and the mixture blended for 15 to 30 minutes. Product specifications were checked as shown in Table 4. Then, remaining water was added in an amount necessary to meet target specifications.

Blending times may be adjusted depending on batch size and blending equipment. The final product blend must be a well-blended batch without unnecessary blending.

TABLE 4

| Parameter | Tolerance | Method |
|---|---|---|
| Brix | 3.90-4.30 | Refractometer |
| Specific gravity | 1.0125-1.0140 | Densitometer |
| Total acidity (as citric) | 7.95-8.90 mL titrant | Titration |
| Nitrogen | Tunnel/Can spec | |
| Sensory | To match std. | |
| Color | To match std. | |
| pH | 3.50-3.90 | pH meter |
| Dissolved oxygen | 30-50 ppm | DO meter¹ |

¹Hanna Model HI 9143 portable DO Meter (Hanna Instruments, Smithfield, Rhode Island)

In an embodiment, the beverage canning process can be performed using 12 fl. oz. cans on a production line. Alternatively, a beverage bottling process can be performed using glass or plastic bottles on a bottled water production line.

In its principal embodiment, the product oxygenated aqueous formulation is deposited in an appropriate container, such as a can or bottle, and dosed with liquid oxygen using a doser on a production line as detailed above. Liquid oxygen is added to each individual can by a special liquid nitrogen micro-dosing unit. In order to maintain its liquid phase, oxygen has to be held at extremely low temperature. Once dosed it rapidly expands as it changes phases to a gas, at a ratio of approximately 1 to 861. The small quantity (in mass and vol.) used is not sufficient to freeze the base liquid. Based on the absorption (of gas in liquid) and headspace of a can the dosage may be adjusted to prevent pressure damage while maintaining positive pressure in the can.

Pasteurization Specifications

One the product has been canned in accordance with the above formulations, it was ready for tunnel pasteurizer. The following hold temperature and hold time were used to produce the canned products described herein. Products may also be tested for total plate count, bacteria, yeast and mold.

Hold temperature: 160° F.

Hold time: 10 min

Exit temperature: <90° F.

Standard aqueous beverages may contain a dissolved oxygen content of 2-7 ppm. Using the methods as described herein, an oxygenated beverage may be prepared having a dissolved oxygen content ranging from about 25 ppm to about 50 ppm, preferably in the range of about 35 to 45 ppm.

### Formulation Example 5

| | Dissolved | | |
|---|---|---|---|
| Product | Oxygen (ppm) | LOD | Method |
| Orange Mango | 47.8 | 0.2 | SM4500O-C |
| #53479 | | | 2001 |
| Orange Mango | 34.5 | 0.2 | SM4500O-C |
| #53480 | | | 2001 |
| Grapefruit | 40.4 | 0.2 | SM4500O-C |
| Ginger #53481 | | | 2001 |
| Grapefruit | 42.6 | 0.2 | SM4500O-C |
| Ginger #53482 | | | 2001 |

As shown in Formulation Example 5, dissolved oxygen after canning was measured in a range of between about 35 ppm and 48 ppm in accordance with the method (Eurofins, New Berlin, Wisconsin).

In all of the above processes, standard bottling and filling equipment may be used, along with appropriately scaled conveyer systems, packaging, and storage systems. The finished canned beverages should be stored in such a manner that dissolved oxygen is retained and maintained at levels that are useful to the consumer. In an embodiment, the finished canned beverages can be refrigerated.

The use of the terms “a,” “an,” “the,” and similar referents in the context of describing the presently claimed invention (especially in the context of the claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Use of the term “about” is intended to describe values either above or below the stated value in a range of approx. ±10%; in other embodiments the values may range in value either above or below the stated value in a range of approx. ±5%; in other embodiments the values may range in value either above or below the stated value in a range of approx. ±2%; in other embodiments the values may range in value either above or below the stated value in a range of approx. ±1%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

What is claimed is:

1. A beverage delivery system, comprising:
a container comprising a sidewall coupled between an upper surface and a lower surface;
an aqueous liquid disposed within the container, the aqueous liquid comprising an oxygen content of greater than about 25 ppm (parts per million);
wherein the aqueous liquid and a gas comprising oxygen within the container are configured to provide for a pressure in a range of between approximately 20 PSI (pounds per square inch) and approximately 35 PSI on interior surfaces of the container; and
wherein oxygen within the container causes a force to push on the interior surfaces of the container.

2. The beverage delivery system of claim 1, wherein nitrogen content within the container causes substantially no force to push on the interior surfaces of the container.

3. The beverage delivery system of claim 1, wherein the content of the container comprises substantially no nitrogen.

4. The beverage delivery system of claim 1, wherein the liquid is substantially devoid of nitrogen.

5. The beverage delivery system of claim 1, wherein the liquid comprises an oxygen content of greater than about 35 ppm.

6. The beverage delivery system of claim 1, wherein the liquid comprises an oxygen content of greater than about 45 ppm.

7. The beverage delivery system of claim 5, wherein the aqueous liquid further comprises sugar, erythritol, stevia extract, and monk fruit extract.

8. A method of forming a beverage within a container, comprising:
providing an aqueous liquid within a container, the aqueous liquid substantially devoid of oxygen;
dosing the aqueous liquid with liquid oxygen, wherein dosing the aqueous liquid with oxygen causes the aqueous liquid to have an oxygen concentration within the aqueous liquid that is greater than 25 ppm; and
closing the container to seal the aqueous liquid within the container, wherein the contents of the container push on interior surfaces of the container with a pressure in a range of between approximately 20 PSI and approximately 35 PSI after closing the container.

9. The method of claim 8, further comprising:
pasteurizing the container at an elevated temperature of greater than 125° F. up to about 160° F.

10. The method of claim 8, wherein the aqueous liquid is substantially devoid of nitrogen.

11. The method of claim 8, wherein the aqueous liquid further comprises sugar, erythritol, stevia extract, and monk fruit extract.

12. The method of claim 8, wherein liquid oxygen is added at a flow rate of between about 1.2 mm³/ms and about 2.0 mm³/ms.
